(19) United States
(12) Patent Application Publication
(10) Pub. No.: US 2014/0266948 A1
(43) Pub. Date: Sep. 18, 2014

(54) COMPACT CORRUGATED FEEDHORN

(71) Applicant: University Court of the University of St. Andrews, St. Andrews (GB)

(72) Inventors: Graham Smith, St Andrews Fife (GB); Johannes McKay, St Andrews Fife (GB)

(21) Appl. No.: 13/801,041

(22) Filed: Mar. 13, 2013

(51) Int. Cl. H01Q 13/04

(52) U.S. Cl. CPC H01Q 13/04
USPC 343/773

(57) ABSTRACT

A feedhorn comprising a first section for coupling radiation from a waveguide into the feedhorn, and a second section for coupling radiation from the feedhorn into free space. The second section defines the feedhorn aperture. The first section is configured to allow excitation of HE₁₁ and HE₁₂ modes and suppress excitation of other higher order HE modes. The second section is configured to ensure that the HE₁₁ and HE₁₂ modes are in phase at the feedhorn aperture.

### FIELD OF THE INVENTION

The present invention relates to a compact corrugated feedhorn for millimeter wave and sub-millimeter wave systems.

### BACKGROUND

Many applications in the millimeter and sub-millimeter wave spectrum involve high performance imaging or exploit quasi-optics (QO) for beam transport and control and use corrugated horn antennas to efficiently couple from waveguide to free space modes. These applications include security imaging, high-field electron paramagnetic resonance (EPR) spectroscopy, radiometric remote sensing, radar and radio astronomy. Typically, such applications require high gain antennas with low insertion loss, wide bandwidth, high return loss, high polarization purity and low sidelobe levels. For space based cosmology experiments, there is a particular desire for compact antennas with very low sidelobe levels.

Corrugated feedhorns are high performance antennas that have been used successfully from a few GHz to THz frequencies. Extremely precise machining and high quality electroforming are required for the highest frequencies. Accurate analysis of such structures became possible with the introduction of modal matching software, which calculates the multi-mode scattering matrix for every single corrugation. This allows accurate co-polar and cross-polar beam patterns to be calculated in both the near field and the far field. It also allows new design strategies to be evaluated rapidly. In particular, it allows detailed evaluation of the subtle effects of changing the width and depth of the corrugations in the critical throat region. These largely determine the input match to the horn and how well the balanced hybrid mode conditions are maintained over large bandwidths. In general, the first corrugation is chosen to be approximately half a wavelength deep and then tapers down to quarter wavelength deep corrugations over a period of several wavelengths. The exact depth of the first approximate half-wavelength corrugation largely determines the return loss at a given frequency.

Early designs of corrugated feedhorns often used a linearly tapered internal profile, as shown in FIG. 1, to couple efficiently from a fundamental circular waveguide TE₁₁ mode to the HE₁₁ mode, which in turn couples to the fundamental Gaussian free space mode with efficiencies of approximately 98%. Many quasi-optical system designs effectively assume fundamental mode Gaussian beam propagation. In general, such designs are relatively simple to model and have provided very good performance. However, when designing very low loss, low aberration quasi-optical systems or very high performance antenna systems, the higher order HE₁ₙ modes and higher order Gaussian modes need to be taken into account and can have very significant effects. The energy in these higher order modes is usually responsible for the sidelobe and cross-polar levels of the far-field pattern of the horn antenna, as can be seen in FIG. 2. They can also cause modal resonances in the frequency response of low loss quasi-optical systems that seek to efficiently transmit power from one (transmit) feedhorn to a (receive) feedhorn. Typically, the conventional linearly tapered design achieves sidelobe and cross-polar levels around −27 dB and −30 dB, respectively, which is insufficient for some high performance applications.

To improve on the single profile linearly tapered design, a number of dual profile horns have previously been proposed. FIG. 3 shows an example of a dual profile horn that has a first section that has a sine-squared profile and a second section that has a parallel profile. The parallel profile section is designed to ensure that the HE₁₁ and HE₁₂ modes are in phase at the feedhorn aperture. This offers improved sidelobe performance and a frequency independent phase center, but for large antenna apertures, performance is still non-optimal because of excitation of unwanted higher order modes in the first section, i.e. HE₁₃ and above.

### SUMMARY OF THE INVENTION

According to the present invention, there is provided a feedhorn comprising: a first section for coupling radiation from a waveguide into the feedhorn, and a second section for coupling radiation from the feedhorn into free space, the second section defining the feedhorn aperture, wherein the first section is configured to allow excitation of HE₁₁ and HE₁₂ modes and suppress excitation of other higher order HE modes, for example, by making the diameter of this section below cut-off for the HE₁₃ mode, and the second section is configured to ensure that the HE₁₁ and HE₁₂ modes are in phase at the feedhorn aperture, whilst not exciting higher order modes. Preferably, the first section has a profile that is such that the other higher order modes are below cut off.

An advantage of the invention is that it can lead to compact horns that can provide extremely low side-lobe levels (approximating −50 dB) over wide instantaneous bandwidths (>10%). The invention can be applied to a corrugated horn (or any horn with high impedance walls) of any cross-sectional structure, (such as rectangular) albeit with different dominant mode-sets.

The relative amplitude of the HE₁₂ mode in the first section may be in the range 0.1 to 0.5, preferably in the range 0.15 and 0.3, for example 0.22. The relative amplitude of the HE₁₁ mode may be in the range 0.99 to 0.86.

The first section may have a profile that increases from the input end of the feedhorn towards the second section, the increase being sufficient to excite the HE₁₂ mode. The first section may have a profile that increases continuously until the HE₁₂ mode is excited. The first section may have a profile that increases discontinuously to allow excitation of the HE₁₂ mode.

The first section may be shaped to transition smoothly into the second section.

The second section may have a linear taper profile.

The second section may have a linear taper profile and the first section may have a profile that transitions to a taper that has the same slope as that of the taper of the second section.

The first section may have a tanh profile and the second section may have a linearly tapered profile to the desired horn aperture. This design allows the possibility of even better sidelobe performance, with predicted sidelobes below −50 dB for horns that are significantly shorter than alternative designs.

The second section may be cylindrical.

Preferably, the feedhorn is corrugated. However, the invention could equally be applied to a non-corrugated antenna that has a high impedance inner surface that is sufficient to substantially suppress current flow along the antenna wall.

According to another aspect of the invention, there is provided method of designing a feedhorn comprising defining a first section for coupling radiation from a waveguide into the feedhorn, such that the first section is configured to allow excitation of HE₁₁ and HE₁₂ modes and suppress excitation of other higher order HE modes, and defining a second section for coupling radiation from the feedhorn into free space, such that the second section is configured to ensure that the HE₁₁ and HE₁₂ modes are in phase at the feedhorn aperture.

### BRIEF DESCRIPTION OF THE DRAWINGS

Various aspects of the invention will now be described by way of example only, and with reference to the accompanying drawings, of which:

FIG. 1 is a cross-section of early design of corrugated feedhorns with a linearly tapered internal profile;

FIG. 2 is a plot of sidelobe and cross-polar levels of a far-field pattern of a horn antenna;

FIG. 3 is a cross-section of a dual profile feedhorn with a first section that has a sine-squared profile and a second section with a parallel profile;

FIG. 4 is plot of power coupling efficiency versus normalized Guassian beam parameter for the lowest HE₁ₙ modes;

FIG. 5 is a plot of the relative amplitudes of the HE₁₁, HE₁₂ and HE₁₃ modes required for optimum Gaussian power coupling, assuming that the modes are in phase at the aperture;

FIG. 6 is a cross-section of a dual profile corrugated feedhorn that has a first section that has a tanh profile and a second section that has a linearly tapered profile—the associated Gaussian beam is also shown;

FIG. 7 is a plot of predicted far field patterns at 94 GHz from CORRUG simulations for 22 dBi feedhorns for the feedhorn of FIG. 6, and a conventional linearly tapered corrugated design, and

FIG. 8 is a plot of predicted peak first sidelobe level versus frequency from CORRUG simulations, for the feedhorn of FIG. 6.

### DETAILED DESCRIPTION OF THE DRAWINGS

The corrugated horn antenna is a well-known high frequency microwave antenna structure that produces high polarization purity antenna patterns with low sidelobe levels. It is usually excited from a single-mode rectangular waveguide. The natural mode set for describing a propagating (approximately linearly polarized) electromagnetic beam pattern within a circular corrugated horn, is the HE₁ₙ mode set containing the HE₁₁ mode, HE₁₂ mode, HE₁₃ mode and so on. In general, these modes propagate with different phase velocities. Any output beam from a corrugated horn can be characterized by an appropriate orthogonal Laguerre-Gaussian beam set, i.e. the sum of a set of Laguerre-Gaussian modes.

To optimize performance of a corrugated feedhorn in terms of side-lobe level performance, it is desirable to primarily excite an output beam that has similar characteristics to just a single fundamental Laguerre-Gaussian beam (which has no side-lobes), and avoid excitation of higher order Gaussian modes. An output fundamental Gaussian beam can almost be perfectly excited by just the HE₁₁ and HE₁₂ modes as long as they have optimal amplitudes and are brought together in phase at, or very near to, the aperture. The present invention achieves this by using a corrugated feedhorn that has two distinct sections; a first waveguide coupling section, and a second free space coupling section.

The first section of the feedhorn is near the throat of the horn and is configured to allow excitation of HE₁₁ and HE₁₂ modes and suppress excitation of other higher order HE modes. A wide range of smooth profiles will achieve this, without exciting higher order HE₁ₙ modes significantly. One method of limiting higher order mode excitation is to excite the HE₁₂ mode whilst the HE₁₃ and other higher order modes are below cut-off. This can be achieved by varying the radial profile as a function of horn length to excite the optimal amplitudes of the HE₁₁ and HE₁₂ modes, whilst not exciting higher order modes (in this context, the radial profile of the horn as a function of length is the internal profile of the horn before slots are manufactured to create the corrugations). The desired amplitude ratio of the HE₁₁ and HE₁₂ modes is governed by the desired aperture efficiency and sidelobe level performance.

The second section of the feedhorn is configured to ensure that the HE₁₁ and HE₁₂ modes are in-phase at the feedhorn aperture and to avoid extra excitation of higher order HE modes. This can be done, for example, by using a parallel phasing section or straight linear taper. In principle, any taper that is slowly varying in aperture radius and limits is possible, but a preferred embodiment is a straight linear taper from the first section of the feedhorn to the desired aperture radius. The exact angle of the taper and the length of the horn for the desired aperture must be calculated numerically so that the HE₁₁ and HE₁₂ modes arrive in phase at the aperture.

By setting as design constraints suppression of third and higher order HE modes in the first section of the feedhorn, and in-phase transmission of the HE₁₁ and HE₁₂ modes at the feedhorn aperture in the second section, the feedhorn design process is greatly simplified and improved.

In the first section of the feedhorn, it is important to transition to a radial horn profile whose radius changes linearly (or slowly) with horn length, and continues to change linearly (or slowly) into the second section to the desired horn aperture, to minimize excitation of higher order modes. The exact slope and length of horn required is determined by the constraint that the HE₁₁ and HE₁₂ modes need to arrive in phase at or near the aperture, and the desired horn aperture. This can be calculated, for example, using mode-matching software.

The exact proportions of HE₁₁ and HE₁₂ modes excited within first section of the horn can be easily and accurately calculated using known mode-matching software for a given change in cross-sectional profile. Almost any change in slope in this region will cause some excitation of the HE₁₂ mode. Thus, there are many profiles that could be chosen, although it is usually helpful to make transitions smooth to reduce reflections of the HE₁₁ mode. In general, the faster the change the change in slope in the first section, the shorter the excitation region needs to be. In principle, any rapid change in horn profile is possible provided it excites the desired HE₁₂ amplitude, whilst the HE₁₃ mode is below cut-off. In a preferred embodiment the first section has a tanh profile. This will be described in more detail later.

In the first section, the relative amplitude of the HE₁₂ mode is chosen to be between 0.1 to 0.5, but more usually lies between 0.15 and 0.3. A typical value is 0.22. The relative amplitude level of the HE₁₁ mode therefore varies from approximately 0.99 to approximately 0.86. (Normalization requires that the sum of the relative amplitudes of the modes squared must equal one). In general, if a small relative amplitude of the HE₁₂ mode is excited it will lead to a larger antenna aperture efficiency (when combined appropriately with the HE₁₁ mode). In contrast, if a high relative amplitude of HE₁₂ mode is excited it will lead to a reduction in the antenna aperture efficiency. Coupling efficiency to a fundamental Gaussian mode is optimized when the relative excitation of the HE₁₂ mode is approximately 0.3. As high coupling efficiencies and high aperture efficiencies are commonly desired this often puts the desired HE₁₂ relative amplitude between 0.15 and 0.3.

Before describing the invention in more detail, some background information on mode propagation in a feedhorn will be reviewed. When analyzing the propagation from an input circular waveguide through corrugated horn to free space, three mode sets are required, where it is assumed any transition from rectangular to circular waveguide is out of the extent of the feedhorn. The TEₘₙ and TMₘₙ modes are the natural mode sets to consider for smooth circular waveguide, and are used in the modal matching software CORRUG to calculate the scattered modes from each individual, circular corrugation element. However, the HEₘₙ and EHₘₙ hybrid modes are often the more natural mode set to describe propagation in a corrugated circular waveguide, as usually fewer modes need be considered compared to the TE and TM modes. Similarly the Laguerre-Gaussian LG₀ₚ mode set is particularly appropriate for analyzing the free space beams with cylindrical symmetry that are typically produced by corrugated feedhorns.

From symmetry considerations, if a single dominant polarization is excited in the horn, only the TE₁ₙ, TM₁ₙ, or HE₁ₙ, EH₁ₙ mode sets will propagate within the horn and are given by:

$$\begin{matrix}{E}_{{TE}_{l n}} = {A}_{{TE}_{l n}} \frac{{k}_{0} a}{{p}_{l n}^{′}} ( \begin{matrix}{J}_{0} [ {p}_{l n}^{′} \frac{r}{a} ] \hat{i} + {J}_{2} [ {p}_{l n}^{′} \frac{r}{a} ] \cdot \\ ( \hat{i} cos [ 2 φ ] + \hat{j} sin [ 2 φ ] )\end{matrix} ) & ( 1 ) \\ {E}_{{TM}_{l n}} = {A}_{{TM}_{l n}} \frac{{β}_{l n} a}{{p}_{l n}} ( \begin{matrix}{J}_{0} [ {p}_{l n} \frac{r}{a} ] \hat{i} - {J}_{2} [ {p}_{l n} \frac{r}{a} ] \cdot \\ ( \hat{i} cos [ 2 φ ] + \hat{j} sin [ 2 φ ] )\end{matrix} ) & ( 2 ) \\ {E}_{{HE}_{l n}} = {A}_{{HE}_{l n}} \frac{{k}_{0} a}{{p}_{2 n}} ( \begin{matrix}{J}_{0} [ {p}_{1 n} \frac{r}{a} ] \hat{i} + \frac{{Xp}_{0 n}^{2}}{4 {Z}_{0} {k}_{0} a} {J}_{2} [ {p}_{0 n} \frac{r}{a} ] \cdot \\ ( \hat{i} cos [ 2 φ ] + \hat{j} sin [ 2 φ ] )\end{matrix} ) & ( 3 ) \\ {E}_{{EH}_{l n}} = {A}_{{EH}_{l n}} \frac{{k}_{0} a}{{p}_{0 n}} ( \begin{matrix}{J}_{2} [ {p}_{0 n} \frac{r}{a} ] \cdot \\ ( \hat{i} cos [ 2 φ ] + \hat{j} sin [ 2 φ ] )\end{matrix} ) & ( 4 )\end{matrix}$$

where (r, Ø, z) refer to the cylindrical coordinate system, k₀ is the wave number, a is the waveguide radius, pₘₙ are the mth root of the equation Jₙ(x)=0,p′ₘₙ is the first derivative of pₘₙ,βₘₙ is the propagation constant, X is the normalized reactance of the corrugations and Z₀ is the impedance of free space.

At the aperture of the horn, it becomes more natural to consider the propagation of the beam as a Gaussian mode set where the TE₁ₙ, TM₁ₙ, or HE₁ₙ, EH₁ₙ modes will naturally couple to the Laguerre-Gaussian LG₀ₚ and LG₂ₚ mode sets given by:

$$\begin{matrix}{E}_{{LG}_{0 p}} ( u ) = {A}_{{LG}_{0 p}} {L}_{0 p} [ \frac{2 {r}^{2}}{{u}^{2} {a}^{2}} ] exp [ \frac{- {r}^{2}}{{u}^{2} {a}^{2}} ] \cdot exp [ \frac{- {ik}_{0} {r}^{2}}{2 {R}_{0}} ] exp [ i ( 2 p + 1 ) arctan [ \frac{z}{{z}_{R}} ] ] & ( 5 ) \\ {E}_{{LG}_{2 p}} ( u ) = {A}_{{LG}_{2 p}} {L}_{2 p} [ \frac{2 {r}^{2}}{{u}^{2} {a}^{2}} ] exp [ \frac{- {r}^{2}}{{u}^{2} {a}^{2}} ] \cdot exp [ \frac{- {ik}_{0} {r}^{2}}{2 {R}_{0}} ] exp [ i ( 2 p + 3 ) arctan [ \frac{z}{{z}_{R}} ] ] \cdot ( cos [ 2 φ ] , sin [ 2 φ ] ) & ( 6 )\end{matrix}$$

where Lₘₚ is the Laguerre polynomial, u is the normalized Gaussian beam parameter, R₀ is the radius of curvature of the phase front at the aperture and z_{R} is the Rayleigh range (πω₀²/λ₀ where ω₀ is the beam waist radius and λ₀ is the free space wavelength). It is relatively simple to transform from the TE, TM mode set to the HE, EH mode set (or the Laguerre-Gaussian mode set at the aperture) by calculating appropriate coupling integrals. These were calculated using Mathematica from the output TE and TM mode sets provided by the mode-matching software CORRUG. Using this approach, the power coupling efficiency to the fundamental Gaussian mode was calculated for combinations of the three lowest order HE₁ₙ modes, as a function of the normalized Gaussian beam parameter u=ω/a₀ where ω is the beam waist radius at the aperture and a₀ is the horn aperture radius.

FIG. 4 shows that the maximum fundamental mode Gaussian power coupling efficiency increases from 98.1% for HE₁₁ only, to 99.8% for HE₁₁+HE₁₂, and virtually 100% for HE₁₁+HE₁₂+HE₁₃. Therefore, most of the power is contained in just these first three modes. Power coupling is maximized in these three cases for u values of 0.64, 0.50 and 0.43 respectively, indicating a progressive reduction in aperture efficiency as the mode set better approximates a Gaussian. The coupling of the HE₁ₙ mode set to the fundamental Gaussian free space mode requires that the individual modes have specific amplitude and phase relationships. Optimum coupling occurs when the modes are in phase at the aperture and have relative amplitudes given by the curves in FIG. 5.

The above analysis presents the desirable HE₁ₙ modal content at the aperture of the horn to achieve given levels of coupling efficiency to a fundamental Gaussian beam. The challenge for the designer is to generate that specific desired mode set with the correct amplitude and phase relationships. In general, higher order HE₁ₙ modes are not excited in straight sections of parallel corrugated pipe, and their excitation is relatively small for narrow angle linear tapers. However, they can be excited strongly whenever there is a change in slope of the corrugated guide profile. In practice, modal matching software needs to be used to calculate exact values of HE₁ₙ excitation over extended lengths. For the examples described herein horns were designed using the CORRUG mode matching software, which has previously been shown to given excellent agreement with experiment, for example down to −60 dB sidelobe levels at 600 GHz.

FIG. 6 shows a feedhorn that has two sections, one designed specifically to suppress the HE₁₃ mode by exciting the desired HE₁₂ mode amplitude in a region in the horn where the HE₁₃ mode is still below cut-off, and another designed to bring the HE₁₁ and HE₁₂ modes into phase at the aperture. The region in which the HE₁₂ mode is excited corresponds to a region where the radius is <1.377 λ₀. The transition to the desired horn aperture, where the HE₁₁ and HE₁₂ modes are in phase, can be effected by a straight linear corrugated taper. The angle of the taper must be carefully chosen to reach the desired aperture, whilst ensuring the HE₁₁ and HE₁₂ modes are still in phase at the aperture.

After investigating a number of profiles, the following function was derived to generate the desired profiles:

$$r ( z ) = {r}_{th} + ( {a}_{0} - {r}_{th} ) \cdot [ \frac{( 1 - A ) z}{{L}_{profile}} + \frac{A}{2} ( tanh ( \frac{B π z}{2 {L}_{profile}} - π ) + 1 ) ] \qquad ( 12 )$$

where A and B are adjustable parameters, rth is the throat radius, and a₀ is the aperture radius. Both A and B are adjusted to excite the correct HE₁₂ amplitude and phase at the aperture, whilst minimizing the excitation of the HE₁₃ and higher order modes.

Simulated beam patterns are shown in FIG. 7 for the tanh/linear dual profiled horn of FIG. 6. For comparison, simulated beam patterns are also shown for the sine-squared/parallel profiled horn of FIG. 3 and a straight linearly tapered horn of the type shown in FIG. 1 at a nominal center frequency of 94 GHz. In each case, the aperture radii have been chosen to provide an approximate gain of 22 dBi. The tanh/linear dual-profiled horn has predicted sidelobes at the −50 dB level with 99.5% of the power in the fundamental mode Gaussian beam. In this design, u=ω/a₀=0.54, and the length is ⅔ that of the other horns. In terms of its overall length and predicted sidelobe performance, this represents state-of-the-art performance for a short corrugated horn.

Table 1 gives the key simulated parameters for the tanh/linear dual profile horn in comparison to the sine-squared/parallel profiled horn of FIG. 3, and the linearly tapered horn of FIG. 1. The very low level of excitation of the HE₁₃ mode should be noted for the tanh/linear dual profile horn:

TABLE I
A COMPARISON OF THREE FEEDHORNS WHOSE
DIMENSIONS HAVE BEEN CHOSEN TO PROVIDE A
CONSISTENT GAIN AND LOW SIDELOBE LEVELS.

| | Linear | | sine-squared/ | | tanh/linear dual | |
|---|---|---|---|---|---|---|
| | taper horn | | parallel profile horn | | profile horn | |
| Radius, a₀ | 7.66 | mm | 8.30 | mm | 8.65 | mm |
| Length, Lₕₒᵣₙ | 102 | mm | 101 | mm | 66.3 | mm |
| Gain | 22 | dBi | 22 | dBi | 22 | dBi |
| μ = w/a₀ | 0.64 | | 0.57 | | 0.545 | |
| First sidelobe | −27 | dB | −37 | dB | −50 | dB |

| | | | |
|---|---|---|---|
| HE₁₁ amplitude | 0.997 | 0.982 | 0.974 |
| HE₁₂ amplitude | 0.075 | 0.184 | 0.222 |
| HE₁₃ amplitude | 0.009 | 0.035 | 0.003 |

Computer simulations of designs in accordance with the invention have shown that excellent performance is maintained over wide bandwidths in terms of both cross polarization and far-field beam patterns. FIG. 8 shows the calculated sidelobe levels for the tanh/linear designs. They are expected to work well over large bandwidths, comparable to standard corrugated horns and be scalable to almost any frequency. The tanh/linear dual profiled design significantly shortens the length of the horn and improves sidelobe level performance at a very modest cost in aperture efficiency. This design is appropriate for any antenna system where weight, size and performance are at a premium.

In summary, the feedhorn of the present invention transitions from a conventional corrugated guide supporting the HE₁₁ mode to a section in which the horn diameter increases (usually smoothly to reduce reflections of the HE₁₁ mode) to an extent where the HE₁₁ and HE₁₂ modes can propagate, but the HE₁₃ mode is below waveguide cut-off. The curvature of the horn profile then varies to excite the desired relative amplitude of HE₁₂ mode (e.g. between 0.1 to 0.5 and typically 0.22). The excitation can be calculated using mode-matching software. As part of the radial variation there is a transition to a linear taper, which continues to the desired horn aperture. The exact profile of the transition to the horn aperture is designed to minimize the excitation of higher order modes. An example would be a linear taper of slope less than 30 degrees. The overall length of the horn and the slope of the linear taper are determined via mode-matching software or otherwise by the condition that the HE₁₁ and HE₁₂ modes should be in phase at (or near) to the aperture. Usually the smallest length is chosen.

The present invention provides short, ultra-low sidelobe scalar corrugated feedhorns that maintain relatively high aperture efficiencies. The horns are relatively easy to design and manufacture, and present clear advantages over previous designs for many radar and quasioptical applications in the millimeter and sub-millimeter wave regimes. It is possible to achieve −50 dB sidelobe levels, over wide bandwidths with short horns.

A skilled person will appreciate that variations of the disclosed arrangements are possible without departing from the scope of the invention. For example, although in the examples described, the first section of the feedhorn has a profile that varies smoothly and continuously over its length to allow the HE₁₂ mode to be excited, whilst maintaining a below cut off condition for higher order modes, in fact a discontinuous or step profile could equally be used. Accordingly the above description of the specific embodiment is made by way of example only and not for the purposes of limitations. It will be clear to the skilled person that minor modifications may be made without significant changes to the operation described.

What is claimed is:

1. A feedhorn comprising:
a first section for coupling radiation from a waveguide into the feedhorn; and
a second section for coupling radiation from the feedhorn into free space, the second section defining the feedhorn aperture,
wherein the first section is configured to allow excitation of HE₁₁ and HE₁₂ modes and suppress excitation of other higher order HE modes, and the second section is configured to ensure that the HE₁₁ and HE₁₂ modes are in phase at the feedhorn aperture.

2. A feedhorn as claimed in claim 1, wherein the first section has a profile that is such that the other higher order modes are below cut off.

3. A feedhorn as claimed in claim 1, wherein the relative amplitude of the HE₁₂ mode in the first section is in the range 0.1 to 0.5, preferably in the range 0.15 and 0.3, for example 0.22.

4. A feedhorn as claimed in claim 1, wherein the relative amplitude of the HE₁₁ mode is in the range 0.99 to 0.86.

5. A feedhorn as claimed in claim 1, wherein the first section has a profile that increases from the input end of the feedhorn towards the second section, the increase being sufficient to excite the HE₁₂ mode.

6. A feedhorn as claimed in claim 5, wherein the first section has a profile that increases continuously until the HE₁₂ mode is excited.

7. A feedhorn as claimed in claim 5, wherein the first section has a profile that increases discontinuously to allow excitation of the HE₁₂ mode.

8. A feedhorn as claimed in claim 5, wherein the first section has a tanh profile.

9. A feedhorn as claimed in claim 1, wherein the first section transitions smoothly into the second section.

10. A feedhorn as claimed in claim 1, wherein the second section has a linear taper profile.

11. A feedhorn as claimed in claim 1, wherein the second section has a linear taper profile and the first section profile transitions to a taper that has the same slope as that of the taper of the second section.

12. A feedhorn as claimed in claim 1, wherein the second section has a cylindrical cross section.

13. A feedhorn as claimed in claim 1, wherein the feedhorn is corrugated.

14. A method of designing a feedhorn, the method comprising:
defining a first section for coupling radiation from a waveguide into the feedhorn, such that the first section is configured to allow excitation of HE₁₁ and HE₁₂ modes and suppress excitation of other higher order HE modes; and
defining a second section for coupling radiation from the feedhorn into free space, such that the second section is configured to ensure that the HE₁₁ and HE₁₂ modes are in phase at the feedhorn aperture.
